(19) United States
(12) Patent Application Publication
(10) Pub. No.: US 2006/0050167 A1
(43) Pub. Date: Mar. 9, 2006

(54) Photo navigation on a digital camera

(76) Inventors: Vincent Skurdal, Boise, ID (US); Mark Brown, Boise, ID (US); Shane Ghering, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/935,055

(22) Filed: Sep. 7, 2004

(51) Int. Cl. H04N 5/222

(52) U.S. Cl. 348/333.05

(57) ABSTRACT

A digital camera that provide for an efficient technique for locating photographs stored in a data storage device. The digital camera comprises a display, a memory device for storing digital photographs, a navigation device, and processing circuitry coupled to the display, memory device and navigation device. Firmware runs on the processing circuitry and implements a user interface in conjunction with the navigation device and display. The firmware displays a bar graph and a marker on the display identifying the relative location of a currently displayed photograph, and configures the navigation device to selectively move the marker left and right along the bar graph to locate photographs stored in the memory device.

### TECHNICAL FIELD

The present invention relates generally to digital cameras.

### BACKGROUND

With data storage devices for digital cameras currently exceeding one gigabyte, reviewing photographs stored on a storage device is becoming very cumbersome. Prior digital cameras typically allow a user to sequence through the photographs one at a time. Also, some conventional digital cameras allow the user to roll over from the last stored photograph back to the first photograph.

Other conventional cameras allow the user to specify a number of thumbnail pictures that should be displayed on the viewfinder (1, 2, 4, 9, for example). However, this approach requires the camera to read the image data from the data storage device (memory card) and format it appropriately for viewing. This is both time and power consuming.

More particularly, because of the increasing density of memory cards that are supported by these cameras, dealing with the large amounts of data is becoming more difficult. On a 3.3 Megapixel camera, a 512 Megabyte flash memory card can store well over 300 photographs. Nearly all camera's allow a user to sequence through the photographs using a cursor pad or a roller thumb wheel. If the memory card is full or nearly full, it is very time consuming and cumbersome to sequence through the stored photographs one at a time. Also, sequencing through the photographs requires a substantial amount of battery power because the viewfinder is active and the flash memory card is being actively read.

Thus, it is very desirable to allow the user to get to a desired photograph quickly. It would be desirable to have a simple and efficient way to navigate through the stored photographs using a relative position index screen and a roller wheel or a cursor pad.

### SUMMARY

An embodiment of the present invention comprises a system embodied in a digital camera that provide for an efficient technique for locating photographs stored in a data storage device. The digital camera comprises a display, a memory device for storing digital photographs, a navigation device, and processing circuitry coupled to the display, memory device and navigation device. Firmware runs on the processing circuitry and implements a user interface in conjunction with the navigation device and display. The firmware displays a bar graph and a marker on the display identifying the relative location of a currently displayed photograph, and configures the navigation device to selectively move the marker left and right along the bar graph to locate photographs stored in the memory device.

In an exemplary embodiment of the invention, images are not displayed until a user selects the relative location of the image or images using a slider bar (bar graph). Then, after action by the user, or after a short time delay, the image at that relative location is displayed. This conserves considerable battery power such as when still images of movie sequences, or still images from a chain of still images, are displayed without delay in response to the position of the marker relative to the slider bar (bar graph).

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are rear and front views, respectively, of an exemplary digital camera implemented in accordance with the principles of the present invention for locating photographs stored in a data storage device; and

FIG. 2 is a flow diagram illustrating an exemplary method in accordance with an embodiment of the present invention.

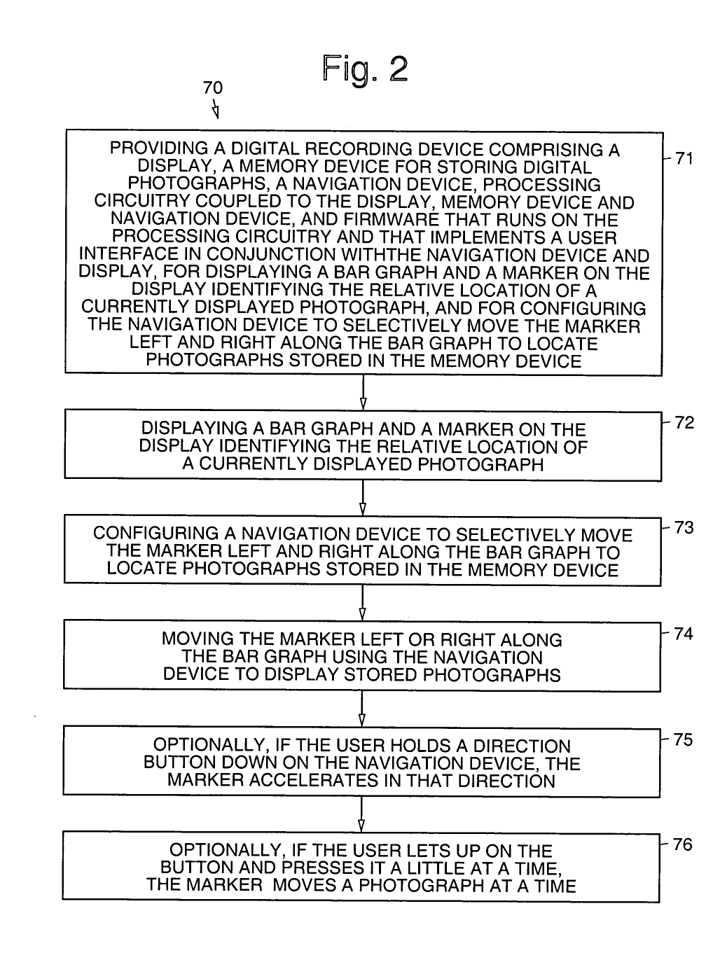

### DETAILED DESCRIPTION

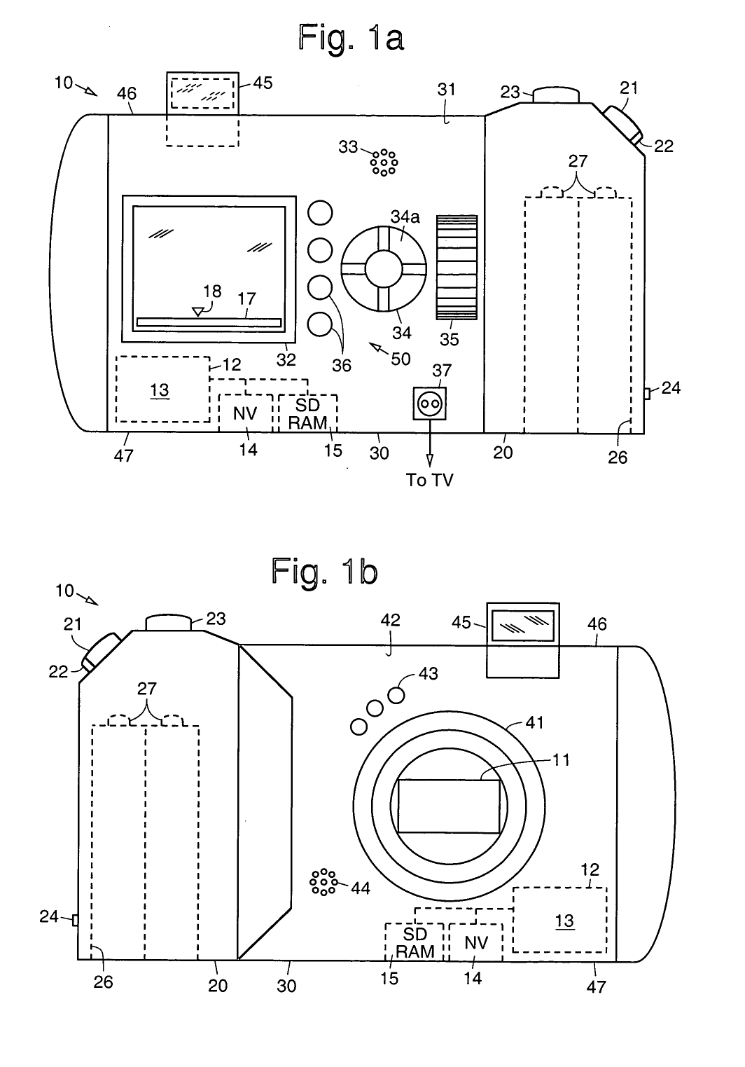

Referring to the drawing figures, FIGS. 1a and 1b are rear and front views, respectively, of an exemplary digital recording device 10 comprising a digital camera 10 implemented in accordance with the principles of the present invention, along with an exemplary user interface 50.

As is shown in FIGS. 1a and 1b, the digital camera 10 comprises a handgrip section 20 and a body section 30. The handgrip section 20 includes a power button 21 or switch 21 having a lock latch 22, a record button 23, a strap connection 24, and a battery compartment 26 for housing batteries 27. The batteries may be inserted into the battery compartment 26 through an opening adjacent a bottom surface 47 of the digital camera 10.

As is shown in FIG. 1a, a rear surface 31 of the body section 30 comprises a liquid crystal display (LCD) 32 (image display 32 or viewfinder 32), a rear microphone 33, a joystick or cursor pad 34 including a plurality of arrow buttons 34a (cursor pad buttons 34a), a zoom control dial 35, a plurality of buttons 36 for setting functions of the camera 10 and implementing a user interface 50 (generally designated in FIG. 1a), and a video output port 37 for downloading images to a computer, or connecting the camera 10 to a television screen (TV), for example. As is shown in FIG. 1b, a lens 41 or zoom lens 41 extends from a front surface 42 of the digital camera 10. A front microphone 44 is disposed on the front surface 42 of the digital camera 10. A flash unit 45 is disposed adjacent a top surface 46 of the digital camera 10.

An image sensor 11 is coupled to processing circuitry 12 (illustrated using dashed lines) that are housed within the body section 30, for example. An exemplary embodiment of the processing circuitry 12 comprises a microcontroller (μC) 12 or central processing unit (CPU) 12. The μC 12 or CPU 12 is coupled to a nonvolatile (NV) storage device 14, such as flash memory 14 (flash memory card 14), for example, and a high speed (volatile) storage device 15, such as synchronous dynamic random access memory (SDRAM) 15, for example.

The processing circuitry 12 (microcontroller (μC) 12 or CPU 12) in the digital camera 10, embodies firmware 13 comprising one or more photo navigation algorithms 13 in accordance with the principles of the present invention. The firmware 13 is operative to rapidly navigate through photographs stored in the flash memory 14 of the digital camera 10. Many currently-available digital cameras 10 have the ability to add additional memory 14 using memory cards 14 such as compact flash cards, secure digital cards, and Sony® Memory Sticks, to name just a few. The density and memory size of these memory cards 14 are becoming increasingly large. Thus, having the ability to quickly and efficiently get to photographs stored on a memory card 14 is very beneficial to the user. The concepts of the present invention may best be described through an example.

A user wants to show a friend some photographs that were taken on his or her digital camera 10. The camera 10 contains a large memory storage card 14 that currently has 300 photographs stored on it. The user knows that the photograph he or she wants is probably stored somewhere in the middle of the card 14. He or she brings up a preview screen on the image display 32 and selects a “Quick Find” graphical mode.

The firmware 13 displays a bar graph 17 and a marker 18 on the display 32 identifying the relative location of a currently displayed photograph, and configures a navigation device 34 (such as the cursor pad 34) to selectively move the marker 18 left and right along the bar graph 17 to locate photographs stored in the memory device 14.

The “Quick Find” graphical mode displays the bar graph 17 on the viewfinder 32 or display 32 and places the marker 18 on or adjacent to the bar graph 17 to show the relative location of the current photograph. The user then moves the marker 18 left or right along the bar graph 17 using the cursor pad 34 or a thumbwheel 35 (retasked zoom control dial 35). If the user holds a direction button 34a down on the cursor pad 34, the marker 18 accelerates in that direction. If the user lets up on the button 34a and presses it a little at a time, the marker 18 moves a photograph at a time.

If the thumbwheel 35 is used, for example, single clicks moves the marker 18 a photograph at a time, while fast rolls move the marker 18 on the order of ten or more photographs at a time. If the input device (cursor pad 34 or thumbwheel 35) is left stable for a predetermined amount of time, then the camera 10 reads the photograph at the current position of the marker 18 and displays it on the viewfinder 32. After a longer time period with no input stimulus, the “Quick Find” bar graph disappears.

In an exemplary embodiment of the present invention, images are not displayed until the user selects the relative location of the image or images using a slider bar 17 (bar graph 17). Then, after action by the user, or after a short time delay, the image at that relative location is displayed. This conserves considerable battery power such as when still images of movie sequences, or still images from a chain of still images, are displayed without delay in response to the position of the marker relative to the slider bar 17 (bar graph 17).

An advantage of the present invention is that navigating through a large number of photographs is greatly improved and reduces wear and tear on the input device, reduces power consumption, and reduces the amount of time it takes to find the desired photograph.

For the purposes of completeness, FIG. 3 is a flow diagram illustrating an exemplary method 70 in accordance with the present invention. The exemplary method 70 is as follows.

A digital recording device 10 is provided 71 comprising a display 32, a memory device 14 for storing digital photographs, a navigation device 34, 35, processing circuitry 12 coupled to the display, memory device and navigation device, and firmware 13 that runs on the processing circuitry and that implements a user interface 50 in conjunction with the navigation device and display, for displaying a bar graph 17 and a marker 18 on the display identifying the relative location of a currently displayed photograph, and for configuring the navigation device to selectively move the marker left and right along the bar graph to locate photographs stored in the memory device.

A bar graph 17 and a marker 18 are displayed 72 on the display 32 identifying the relative location of a currently displayed photograph. A navigation device 34 is configured 73 to selectively move the marker 18 left and right along the bar graph 17 to locate photographs stored in the memory device 14. A user moves 74 the marker 18 left or right along the bar graph 17 using the navigation device 34.

Optionally, if the user holds 75 a direction button 34a down on the navigation device 34, the marker 18 accelerates in that direction. Optionally, if the user lets up on the button 34a and presses 76 it a little at a time, the marker 18 moves a photograph at a time.

If the thumbwheel 35 is used as the navigation device 34, single clicks moves the marker 18 a photograph at a time, while fast rolls move the marker 18 on the order of ten or more photographs at a time. If the navigation device 34 (cursor pad 34 or thumbwheel 35) is left stable for a predetermined amount of time, then the camera 10 reads the photograph at the current position of the marker 18 and displays it on the viewfinder 32. After a longer time period with no input stimulus, the “Quick Find” bar graph disappears.

Thus, digital cameras have been disclosed that provide for rapid location and display of photographs stored in a data storage device. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A digital camera comprising:
a display;
a memory device for storing digital photographs;
a navigation device;
processing circuitry coupled to the display, memory device and navigation device; and
firmware that runs on the processing circuitry and that implements a user interface in conjunction with the navigation device and display, for displaying a bar graph and a marker 18 on the display identifying the relative location of a currently displayed photograph, and for configuring the navigation device to selectively move the marker left and right along the bar graph to locate photographs stored in the memory device.

2. The digital camera recited in claim 1 wherein the navigation device comprises a cursor pad.

3. The digital camera recited in claim 1 wherein the navigation device comprises a thumbwheel.

4. The digital camera recited in claim 1 wherein the firmware configures the navigation device to accelerate in a particular direction if the navigation device is held down.

5. The digital camera recited in claim 1 wherein the firmware configures the navigation device to step one photograph at a time in a particular direction if the navigation device is pressed a single time.

6. The digital camera recited in claim 1 wherein the firmware configures the cursor pad to accelerate in a particular direction if the cursor pad is held down.

7. The digital camera recited in claim 1 wherein the firmware configures the cursor pad to step one photograph at a time in a particular direction if the cursor pad is pressed a single time.

8. The digital camera recited in claim 1 wherein the firmware configures the thumbwheel to accelerate in a particular direction if the thumbwheel is rotated in a particular direction and held down.

9. The digital camera recited in claim 1 wherein the firmware configures the thumbwheel to step one photograph at a time in a particular direction if the thumbwheel is rotated a single time.

10. The digital camera recited in claim 1 wherein the firmware displays the photograph at the current position of the marker on the display if the navigation device is left stable for a predetermined amount of time.

11. The digital camera recited in claim 1 wherein the firmware removes the bar graph from the display after a time period with no input stimulus.

12. A method comprising:
providing a digital recording device comprising a display, a memory device for storing digital photographs, a navigation device, processing circuitry coupled to the display, memory device and navigation device, and firmware that runs on the processing circuitry and that implements a user interface in conjunction with the navigation device and display, for displaying a bar graph and a marker on the display identifying the relative location of a currently displayed photograph, and for configuring the navigation device to selectively move the marker left and right along the bar graph to locate photographs stored in the memory device;
displaying the bar graph and the marker on the display identifying the relative location of a currently displayed photograph;
configuring the navigation device to selectively move the marker left and right along the bar graph to locate photographs stored in the memory device; and
moving the marker left or right along the bar graph using the navigation device to selectively display different photographs.

13. The method recited in claim 12 wherein if the user holds down a direction button 34a on the navigation device 34, the marker accelerates in that direction.

14. The method recited in claim 12 wherein if the user presses the button a little at a time, the marker 18 moves a photograph at a time.

15. A digital camera comprising:
display means;
memory means for storing digital photographs;
navigation means;
processing means coupled to the display, memory device and navigation device; and
firmware that runs on the processing means and that implements a user interface in conjunction with the navigation device and display, for displaying a bar graph and a marker on the display identifying the relative location of a currently displayed photograph, and for configuring the navigation means to selectively move the marker left and right along the bar graph to locate photographs stored in the memory means.

16. The digital camera recited in claim 15 wherein the firmware configures the navigation means to accelerate in a particular direction if the navigation means is held down.

17. The digital camera 10 recited in claim 15 wherein the firmware configures the navigation means to step one photograph at a time in a particular direction if the navigation means is pressed a single time.

18. The digital camera 10 recited in claim 15 wherein the firmware configures a cursor pad to accelerate in a particular direction if the cursor pad is held down.

19. The digital camera recited in claim 15 wherein the firmware configures a cursor pad to step one photograph at a time in a particular direction if the cursor pad is pressed a single time.

20. The digital camera recited in claim 15 wherein the firmware configures a thumbwheel to accelerate in a particular direction if the thumbwheel is rotated in a particular direction and held down.

21. The digital camera recited in claim 15 wherein the firmware configures a thumbwheel to step one photograph at a time in a particular direction if the thumbwheel is rotated a single time.
